(19) United States
(12) Patent Application Publication
(10) Pub. No.: US 2019/0156445 A1
(43) Pub. Date: May 23, 2019

(54) APPLICATION STORE FOR DYNAMICALLY IMPLEMENTING LICENSING SCHEME

(71) Applicant: General Electric Company, Schenectady, NY (US)

(72) Inventors: Joel MARKHAM, Niskayuna, NY (US); David MATTHEWS, Niskayuna, NY (US); Michael YOENSKY, Charlottesville, VA (US); Amy Victoria ARAGONES, Niskayuna, NY (US); Austars Raymond SCHNORE, JR., Scotia, NY (US)

(21) Appl. No.: 15/820,645

(22) Filed: Nov. 22, 2017

(51) Int. Cl. G06Q 50/18; G06Q 30/04; G06F 8/61

(52) U.S. Cl. CPC G06Q 50/184; G06Q 20/1235; G06F 8/61; G06Q 30/04

(57) ABSTRACT

The example embodiments are directed to a system and method for incorporating licensing information into a downloadable application via an application marketplace. In an example, the method includes one or more of receiving a request of an asset control system, at an application marketplace, to download and install an instance of a software application from the application marketplace for use with an asset controlled by the asset control system, dynamically determining a licensing scheme to be used for the instance of the software application from among a plurality of possible licensing schemes based on configuration information stored in a repository associated with the application marketplace, assigning the dynamically determined licensing scheme to a downloadable file of the software application, and transmitting the downloadable file having the dynamically assigned licensing scheme to an industrial edge computing system associated with the asset control system.

### BACKGROUND

Machine and equipment assets are engineered to perform particular tasks as part of a process. For example, assets can include, among other things and without limitation, industrial manufacturing equipment on a production line, drilling equipment for use in mining operations, wind turbines that generate electricity on a wind farm, transportation vehicles, gas and oil refining equipment, and the like. As another example, assets may include devices that aid in diagnosing patients such as imaging devices (e.g., X-ray or MM systems), monitoring equipment, and the like. The design and implementation of these assets often takes into account both the physics of the task at hand, as well as the environment in which such assets are configured to operate.

Low-level software and hardware-based controllers have long been used to drive machine and equipment assets. However, the rise of inexpensive cloud computing, increasing sensor capabilities, and decreasing sensor costs, as well as the proliferation of mobile technologies, have created opportunities for creating novel industrial and healthcare based assets with improved sensing technology and which are capable of transmitting data that can then be distributed throughout a network. As a consequence, there are new opportunities to enhance the business value of some assets through the use of novel industrial-focused hardware and software.

Software applications and other programs are often used as part of a process for enhancing, analyzing, controlling or otherwise interacting with an asset such as a machine or equipment that is used in industry, manufacturing, healthcare, transportation, or the like. Software applications are typically developed by third party developers/publishers and licensed to end users. The license is a legal instrument permitting a user to have access to a copy of the software application (e.g., for a cost, a predetermined amount of time, etc.) and governing the redistribution of the software. Typically, a license restricts movement of the copy of the software application to a predetermined number of devices which are covered by the licensing agreement.

However, different software applications may be subject to different licensing schemes making it difficult for a single platform to support the licensing of software applications. For example, some applications may be one-time purchases, some applications may incur ongoing charges based on performance improvements, some applications may be subject to hybrid licensing scheme models (e.g., one-time fee plus bonus for improvements), some applications may be charged by metered usage, and the like. Furthermore, modern industrial application types that are supported within industrial systems are different than in the past. For example, software applications may have very different terms that support different business models which creates challenges with licensing management in this domain. In addition to different business models, the software may be installed on different devices that may or may not be connected to the Internet. Furthermore, an application may have components that are distributed across the cloud and across sites that are federated in the system that complicates the terms and the management of these licenses.

### SUMMARY

According to an aspect of an example embodiment, a method may include one or more of receiving a request of an asset control system, at an application marketplace, to download and install an instance of a software application from the application marketplace for use with an asset controlled by the asset control system, dynamically determining a licensing scheme to be used for the instance of the software application from among a plurality of possible licensing schemes based on configuration information stored in a repository associated with the application marketplace, assigning the dynamically determined licensing scheme to a downloadable file of the software application, and transmitting the downloadable file having the dynamically assigned licensing scheme to an industrial edge computing system associated with the asset control system.

According to an aspect of another example embodiment, a computing system may include one or more of a network interface configured to receive a request of an asset control system to download and install an instance of a software application from the application marketplace for use with an asset controlled by the asset control system, and a processor configured to dynamically determine a licensing scheme to be used for the instance of software application from among a plurality of possible licensing schemes based on configuration information stored in a repository associated with the application marketplace, and assign the dynamically determined licensing scheme to a downloadable file of the software application, wherein the processor is further configured to control the network interface to transmit the downloadable file having the dynamically assigned licensing scheme to an industrial edge computing system associated with the asset control system.

According to an aspect of another example embodiments, a method may include one or more of receiving a downloadable file for installing a software application from an application marketplace, the downloadable file comprising licensing scheme data associated with a licensing policy for the software application which is dynamically assigned by the application marketplace form among a plurality of licensing schemes, installing the software application and initiating a monitoring operation for the software application based on the licensing scheme data, and optimizing a performance an industrial asset coupled to the industrial edge system using the software application.

Other features and aspects may be apparent from the following detailed description taken in conjunction with the drawings and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a cloud computing system for industrial software and hardware in accordance with an example embodiment.

FIG. 2 is a diagram illustrating a process of an application marketplace assigning licensing information to a software application in accordance with an example embodiment.

FIG. 3 is a diagram illustrating a downloadable file having licensing information incorporated therein according to example embodiments.

FIG. 4 is a diagram illustrating a method for dynamically assigning licensing information to an application in accordance with an example embodiment.

FIG. 5 is a diagram illustrating a computing system for dynamically assigning licensing information to an application in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The example embodiments are directed to an application marketplace which can dynamically configure a downloadable instance of a software application with licensing information such as a licensing scheme from among a plurality of possible licensing schemes. The application marketplace may be used to provide access to software applications that can be downloaded and installed by user devices. Users may register with the application marketplace in general or for specific downloads. During a registration process, a user desiring to download the software application may provide one or more inputs or selections for licensing. As another example, licensing information may be automatically determined by the application marketplace based on one or more predefined attributes of the user such as historical use, similar downloads, or the like. When the application is downloaded to user device or box associated with the user, a downloadable file may be implemented with the dynamically determined licensing information.

According to various aspects, licensing information about the user and about the application may be stored in a repository that is associated with the application marketplace. For example, the repository may be coupled to the application marketplace, triggered by the application marketplace, and the like. When a download request is received for a software application, the application marketplace may dynamically determine a licensing scheme for an instance of a software application to be downloaded based on metadata of the application and/or a user requesting the download which is stored in the application marketplace. Furthermore, the application marketplace may incorporate licensing information into the downloadable file while transferring the downloadable file to a user device or an agent device for installing the application on the user device.

As described herein, an application marketplace refers to a digital distribution platform for software. An application marketplace may organize the applications that it offers based on various factors including functions provided by the app (e.g., games, multimedia, productivity, etc.), a device for which the app was designed, an operating system on which the app will run, and the like. The application marketplace may take the form of an online store, where users can browse through different applications and categories, view information about each app (such as reviews or ratings), and acquire the application. A selected application may be offered as an automatic download, after which the application installs in the target download environment. An application marketplace may include different software applications published by distinct software developers. The application marketplace may receive a uniform resource locator (URL) of an application used to launch the application, screen shots, one or more icons, a manifest file, and the like, from the developer of the application desiring to publish the application through the application marketplace. After the application is submitted, it is often reviewed to ensure various requirements (e.g., security, operation, etc.) and when approved it is made available via the application marketplace.

Software applications may be downloaded from an application marketplace and installed in an IoT environment. Here, the software application may be downloaded to an industrial based computing system such as an industrial box (PC), a gateway, a user device, or the like. The industrial computing system may be included within a control system or it may be a software platform that is running on an edge device which may or may not be distinct from a real-time control system. The industrial computing system may be associated with an industrial asset or a group of assets that are part of a manufacturing plant which operate to perform a business process. For example, optimization software may be used by an asset or a control system of the asset to add life to the asset or its components by changing speeds, power levels, operating conditions, and the like. As another example, optimization applications may be used to improve a level of manufacturing output (e.g., speed) by the asset, a quality of the manufacturing of the asset, and the like. However, before a user downloads an application, it can be beneficial to determine if the application will work with particular characteristics of the target installation environment including software constraints, hardware constraints, and the like.

The system and method described herein may be implemented via a program or other software that may be used in conjunction with applications for managing machine and equipment assets hosted within an Industrial Internet of Things (IIoT). An IIoT may connect assets, such as turbines, jet engines, locomotives, elevators, healthcare devices, mining equipment, oil and gas refineries, and the like, to the Internet or cloud, or to each other in some meaningful way such as through one or more networks. The software program described herein can be implemented within an application marketplace deployed in a “cloud” or remote or distributed computing resource.

The cloud platform or other host computing environment can be used to receive, relay, transmit, store, analyze, or otherwise process information for or about assets and manufacturing sites. In an example, a cloud computing system includes at least one processor circuit, at least one database, and a plurality of users and/or assets that are in data communication with the cloud computing system. The cloud computing system can further include or can be coupled with one or more other processor circuits or modules configured to perform a specific task, such as to perform tasks related to asset maintenance, analytics, data storage, security, or some other function.

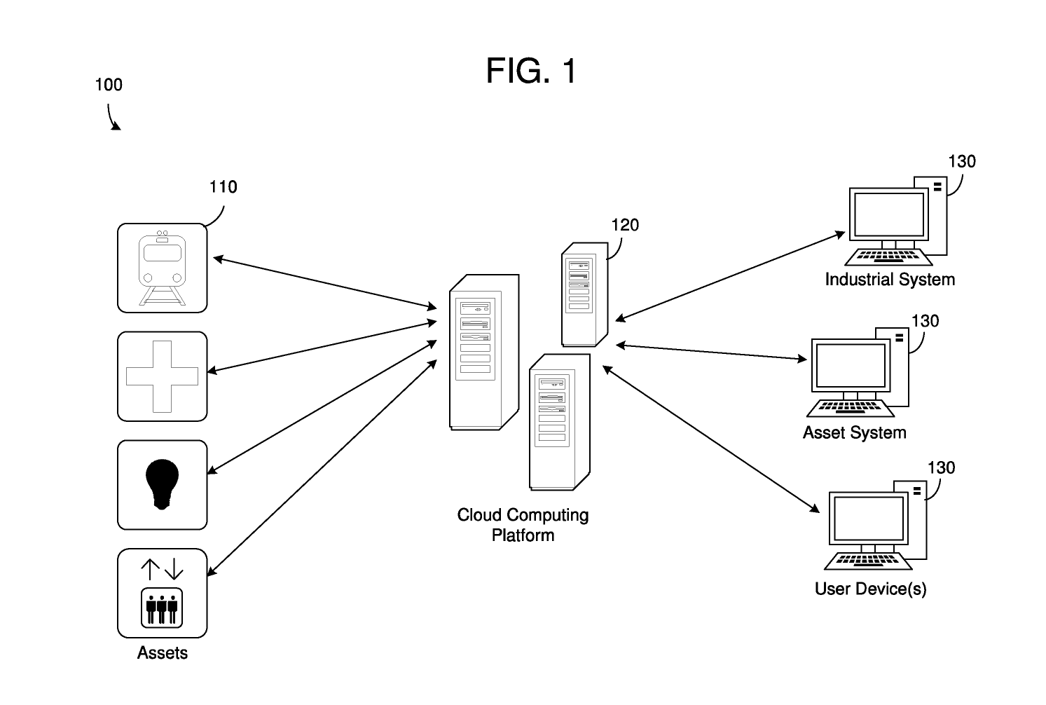

FIG. 1 illustrates a cloud computing system 100 for industrial software and hardware in accordance with an example embodiment. Referring to FIG. 1, the system 100 includes a plurality of assets 110 which may be included within an IIoT and which may transmit raw data to a source such as cloud computing platform 120 where it may be stored and processed. Here, the data may be transmitted directly to the platform 120 or through one or more intermediate devices such as a stream processing, asset computing system, and/or the like. It should also be appreciated that the cloud platform 120 in FIG. 1 may be replaced with or supplemented by a non-cloud based platform such as a server, an on-premises computing system, and the like.

The data transmitted by the assets 110 and received by the cloud platform 120 may include data that is being input to hardware and/or software deployed on or in association with the assets 110, raw time-series data output as a result of the operation of the assets 110, other data collected from or about the assets 110, and the like. Data that is stored and processed by the cloud platform 120 may be output in some meaningful way to industrial devices 130. In the example of FIG. 1, the assets 110, cloud platform 120, and industrial computing systems 130 may be connected to each other via a network such as the Internet, a private network, a wired network, a wireless network, etc. The industrial computing systems 130 may include an asset controlling computing system, an industrial edge computing system coupled to an asset, a gateway, an intervening edge server, a user device, and the like, which may interact with software hosted by and deployed on the cloud platform 120 in order to receive data from, monitor, and/or control operation of the assets 110.

According to various aspects, software applications that can be used to enhance or otherwise used in conjunction with the operation of an asset 110 and may be hosted by the cloud platform 120. The software may interact with the asset 110. For example, software applications may be used to optimize a performance of the assets 110 or data coming in from the asset 110. As another example, the software applications may analyze, control, manage, or otherwise control with the asset 110 and components (software and hardware) thereof. An industrial computing system 130 may receive data and/or views of the data about the asset 110 as the data is processed via one or more applications hosted by the cloud platform 120. For example, the industrial computing system 130 may receive graph-based results, diagrams, charts, warnings, measurements, power levels, and the like. As another example, the industrial computing system 130 may display a graphical user interface that allows a user thereof to input commands to an asset 110 via one or more applications hosted by the cloud platform 120.

In this example, an asset management platform (AMP) can reside within or be connected to the cloud platform 120, in a local or sandboxed environment, or can be distributed across multiple locations or devices and can be used to interact with the assets 110. The AMP can be configured to perform functions such as data acquisition, data analysis, data exchange, and the like, with local or remote assets 110, or with other task-specific processing devices. For example, the assets 110 may be an asset community (e.g., turbines, healthcare, power, industrial, manufacturing, mining, oil and gas, elevator, etc.) which may be communicatively coupled to the cloud platform 120 via one or more intermediate devices such as a stream data transfer platform, database, or the like.

External sensors attached to or otherwise associated with the assets 110 can be used to sense information about a function of an asset, or to sense information about an environment condition at or around an asset, a worker, a downtime, a machine or equipment maintenance, and the like. The external sensor can be configured for data communication with the cloud platform 120 which can be configured to store the raw sensor information and transfer the raw sensor information to the industrial computing system 130 where it can be accessed by users, applications, systems, and the like, for further processing. Here, the data sensed by sensors and provided from the assets 110 may include time-series data or other types of data associated with the operations being performed by the assets 110

In some embodiments, the cloud platform 120 may include a local, system, enterprise, or global computing infrastructure that can be optimized for industrial data workloads, secure data communication, and compliance with regulatory requirements. The cloud platform 120 may include a database management system (DBMS) for creating, monitoring, and controlling access to data in a database coupled to or included within the cloud platform 120. The cloud platform 120 can also include services that developers can use to build or test industrial or manufacturing-based applications and services to implement IIoT applications that interact with assets 110.

According to various aspects, the cloud platform 120 may host an industrial application marketplace where developers can publish their distinctly developed applications and/or retrieve applications from third parties. In addition, the cloud platform 120 can host a development framework for communicating with various available services or modules. The development framework can offer developers a consistent contextual user experience in web or mobile applications. Developers can add and make accessible their applications (services, data, analytics, etc.) via the cloud platform 120. Also, analytic software may analyze data from or about a manufacturing process and provide insight, predictions, and early warning fault detection.

According to various aspects, prior to downloading and installing an application hosted by the cloud platform 120, a user of an industrial computing system 130 may test the application based on one or more hardware and software configurations of the user-specific system. Here, the user system may include at least one asset 110. Also, the user system may include a control system, one or more other assets, additional computers, machines, equipment, and the like, which may be used to perform manufacturing and industrial operations. Collectively, the user system may be referred to as a target system or a target application installation environment that includes software, hardware, or a combination of both software and hardware. The user may interact with the application marketplace hosted by cloud platform 120 (or hosted by a web server not shown) to view available applications. The user may launch the test environment described herein via the application marketplace to test operating environment characteristics of the users target installation environment.

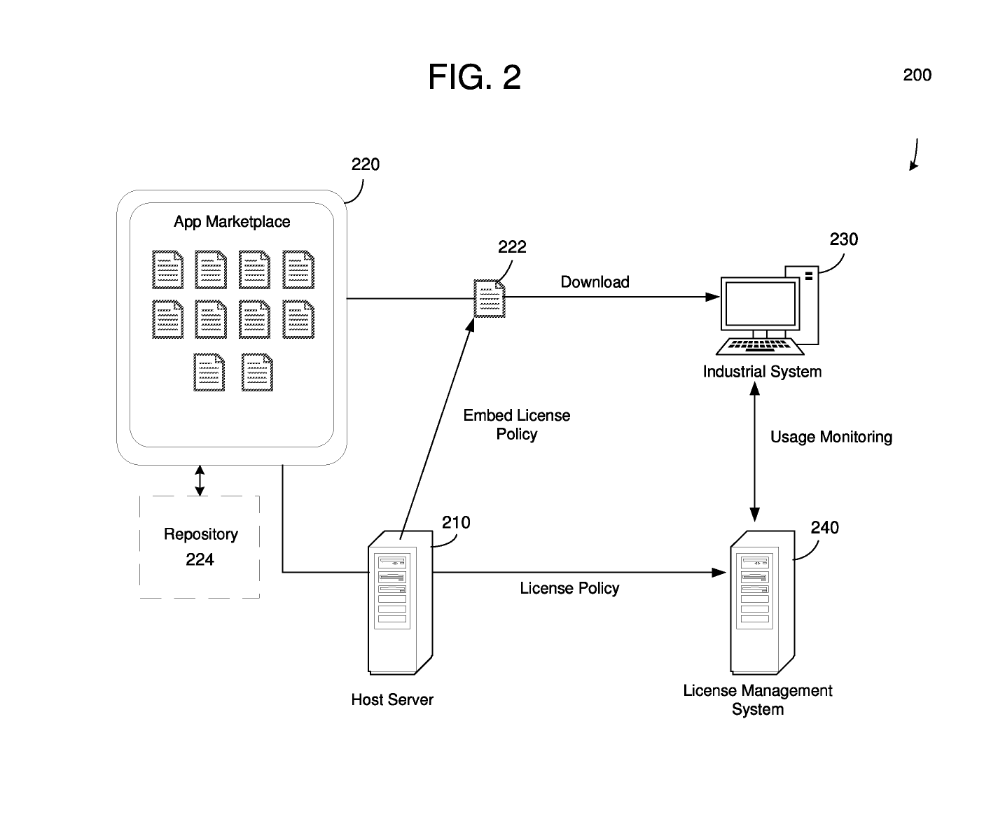

FIG. 2 illustrates a process 200 of an application marketplace assigning licensing information to a software application in accordance with an example embodiment. The system shown in FIG. 2 may be the system 100 shown in FIG. 1, or it may be a different system. Referring to the example of FIG. 2, a host platform 210 hosts an application marketplace 220. In this example, an industrial computing system 230 may connect online to the host platform 210 via a network such as the Internet, private network, offline via a local function, or the like. The system in FIG. 2 also includes a license management system 240 (also referred to as an edge manager) which is capable of managing deployment and usage of applications downloaded to the industrial computing system 230 from the application marketplace 220.

A user/operator of the industrial computing system 230 may browse applications included in the application marketplace 220. For example, the user of the user device 230 may request an application 222 from the host platform 210 via the application marketplace 220. In response, a service associated with the application marketplace may verify whether the industrial system 230 is entitled to download the software application. For example, tracking software entitlement may be performed by an entitlement service that runs on the host server 210 (e.g., cloud, server, etc.), collects data from the edge, and tracks the subscription of an industrial user to verify what they have purchased and what they are entitled to for software running on the edge. There could be different tracking models (e.g., subscriptions, devices, users, etc.) Prior to transmitting the application 222 to the industrial computing system 230, the application 222 may be dynamically assigned a licensing scheme (e.g., billing policy, redistribution policy, usage policy, time limit policy, amount of uses, etc.) by the application marketplace 220. Examples of licensing schemes that may be dynamically assigned include, but are not limited to, subscription, metered usage, improvement-based billing, annual fee, freemium, one-time payment, and the like. The dynamically assigned licensing scheme may also dictate redistribution of the application among user devices.

Licensing information associated with the application 222 as well as other applications included in the application marketplace 220 may be stored in a marketplace repository 224 which is associated with the application marketplace 220. For example, the marketplace repository 224 may be hosted by the host platform 220 or it may be hosted by a remove server or database and triggered by the application marketplace 220 and the host platform 210. The marketplace repository 224 may store metadata of the application 222 such as licensing information that has been received from a user during a registration process for downloading/purchasing the application 222. The marketplace repository 224 may store an identification of the user or the industrial computing system 230 such as a device ID, a user ID, a key, a tag, or the like, and licensing information. Here, the user identification and the licensing information may be stored in association with the application 222. When the industrial computing system 230 requests to download the application 222, the application marketplace 220 may consume the application data/metadata associated with the licensing scheme for the industrial computing system 230 stored in the marketplace repository 224 to determine which licensing scheme to dynamically assign to the application 222. Furthermore, the host platform 210, via the application marketplace 220, may transmit the application 222 having the dynamically assigned licensing scheme to the industrial computing system 230. Furthermore, the host platform 210, via the application marketplace 220, may provide the dynamically assigned licensing scheme information to the license management system 240.

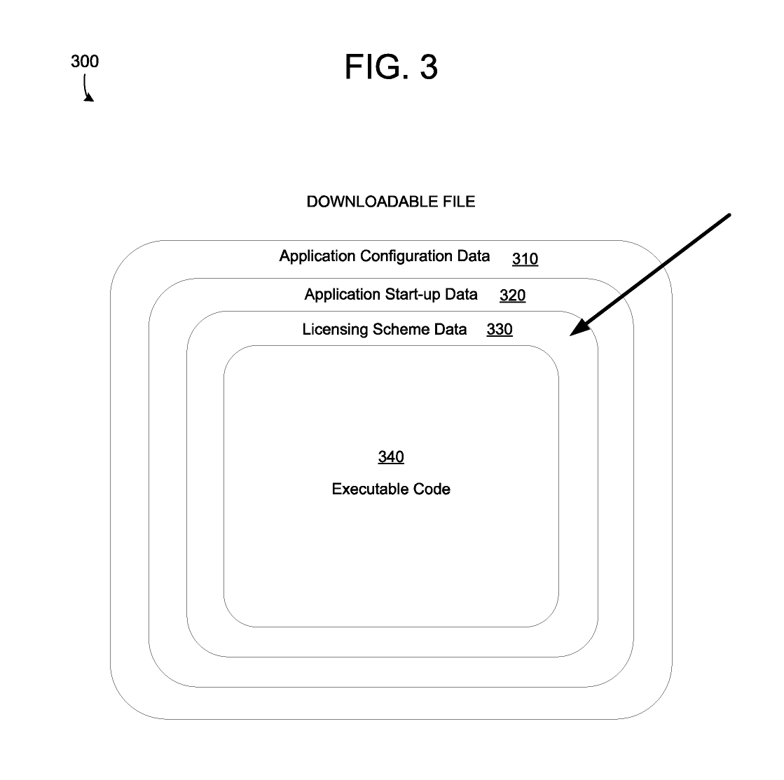

The application marketplace 220 may assign the licensing information/scheme to the application 222 in different ways. For example, as shown in FIG. 3, the application marketplace 220 may assign the licensing information by embedding or otherwise incorporating the licensing information into a downloadable file 300 which corresponds to the application 222 in FIG. 2. For example, the application marketplace 220 may embed or otherwise incorporate licensing scheme data 330 within a storage area or metadata of the downloadable file 300. Here, the downloadable file 300 may be an executable file such as a Tape Archive (TAR) file, a blob, or the like, which includes multiple layers of application-related information. Embedded within the downloadable file 300 may be several layers of information/metadata such as configuration data 310 for the application, compose data 320 for starting-up the application, licensing scheme data 330, executable code 340, and other layers/data not specifically shown.

As another example, the application marketplace 220 may assign the licensing scheme to the application 222 within the license management system 240 which controls when and how the application 222 is downloaded, used, etc. The license management system 240. In this example, the downloadable file does not need to be manipulated or modified but may be downloaded as is. Rather, the licensing information may be controlled by an external system such as the license management system 240 which can detect log data of the application 222 being used and executed by the industrial computing system 230, for example, based on an application identifier, a device identifier, a user identifier, and the like.

In some embodiments, the industrial computing system 230 may include a service that is stored in a trusted component or other security element of the industrial computing system 230 which controls usage of the application 222 on the industrial computing system 230. The service may also or instead have a component that is stored on the license management system 240. In an example in which the service is installed on both the industrial computing system 230 and the licensing management system 240, the service may communicate between the two systems. The service may ensure that the application 222 is not being used/provisioned outside of the designated parameters of the dynamically assigned licensing scheme. For example, the service may white list use of the application 222 by the industrial computing system 230 thereby allowing the industrial computing system 230 to download and install the application 222. As another example, the service may also control redistribution of the application 222 on other devices associated with the industrial computing system 230. The service may also control billing and other data of the application 222 which is monitored by the license management system 240.

As another example, the application marketplace 220 may deploy the application 222 (or components thereof) to multiple industrial systems such as both an asset controller system and an edge device coupled to the asset. In this example, the application 222 install package may include both a monitoring component that runs on the edge device coupled to the asset and a set of optimization firmware that runs on the asset controller. For example, if a “fee for performance” license model is chosen or the like, then the edge device-based monitoring component on the edge device can attach to the firmware on the asset controller and begin monitoring the asset for the purpose of determining how much to charge the licensee.

Alternatively, if a standard license scheme is selected (e.g., pay for the installation), then the monitoring component may be absent or reduced to just the license-management role. According to various aspects, the application marketplace 220 may programmatically alter the deployment of the application 222 based on which license type is selected as well whether the monitoring component is included. Accordingly, the application 222 may be a single application that has multiple possible deployment packages and the application marketplace 220 may dynamically select which deployment package to use for the download of the application 222 based on the chosen licensing scheme.

For example, the industrial system 230 (e.g., an industrial edge device) may receive a downloadable file for installing a software application 222 from the application marketplace 222. In this example, the downloadable file may include licensing scheme data associated with a licensing policy for the software application which is dynamically assigned by the application marketplace 220 from among a plurality of licensing schemes. In response, the industrial system 230 may install the software application 222 and initiate a monitoring operation for the software application 222 based on the licensing scheme data included in the deployment package. Furthermore, the industrial system 230 may optimize a performance an industrial asset coupled to the industrial system 230 using the software application 222. In some embodiments, the initiating of the monitoring application by the industrial system 230 may include transmitting application data and an identification of the industrial edge system 230 to the licensing management system 240 associated with the application marketplace 220. As another example, the monitoring may include extracting a monitoring component from the application 222 download, and initiating the monitoring operation by executing the monitoring component at the industrial edge system 230. In this example, the monitoring component may also be transmitted to an asset control system that executes firmware associated with the monitoring and which attaches to the monitoring component being executed by the industrial system 230 (e.g., edge device system).

In some embodiments, the application 222 may be downloaded directly to the industrial computing system 230 via a network connection. As another example, the application 222 may be deployed to the industrial computing system 230 via an offline procedure via an agent device. In this example, the industrial computing system 230 may be offline and not connected to the application marketplace 220. The offline method may use a web browser with a local connection to the industrial computing system 230 which receives the application 222 from an agent device. In both the online and offline deployment models, the license managing system 240 may perform license tracking and monitoring. For example, in the offline model, the reporting mechanism may include the customer (i.e., industrial computing system 230) sending application usage data via a utility (e.g., phone call, records, email, etc.). It should also be appreciated that industrial computing system 230 may be an industrial-based asset control system that controls one or more assets (such as assets 110) shown in FIG. 1.

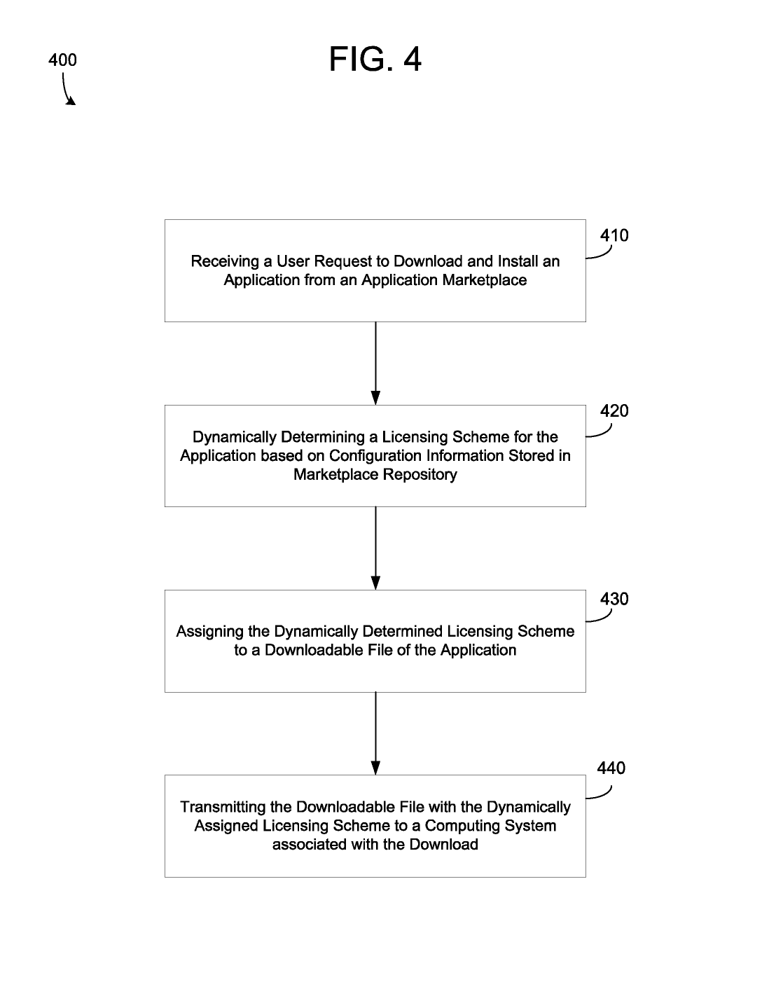

FIG. 4 illustrates a method 400 for dynamically assigning licensing information to an application in accordance with an example embodiment. For example, the method 400 may be performed by a server, a cloud computing platform, a database, a computing system, a user device, and the like. Referring to FIG. 4, in 410, the method includes receiving a request of an asset control system, at an application marketplace, to download and install an instance of a software application from the application marketplace for use by the asset control system with one or more assets. For example, the request may be received from the asset control system or from an intervening edge server associated with the asset control system for requesting to download and install a copy or an instance of the application to the asset control system or to an edge device coupled to the asset. The asset control system and/or the edge device may be a user computing system such as a computer, a tablet, a mobile device, an appliance, and the like, an industrial PC, a gateway, or other edge device. As another example, the user device may be a control system used at an industrial manufacturing plant or other location in which the user device is able to interact with, manage, and/or control assets performing industrial manufacturing operations, healthcare, energy acquisition, transportation, and the like.

In 420, the method includes dynamically determining a licensing scheme to be used for the instance of the software application from among a plurality of possible licensing schemes based on configuration information stored in a repository associated with the application marketplace. For example, the determined licensing scheme may include a billing policy for the instance of the software application, a redistribution restriction policy for the instance of the software application, and the like. The configuration information may be stored in the repository associated with the application marketplace and which includes information received by the application marketplace from a user during a registration process for downloading the software application to a user device. As another example, the configuration information may be received directly from a user or it may be determined automatically by the application marketplace based on one or more features such as previous user downloads, application type, download setting, and the like.

In 430, the method includes assigning the dynamically determined licensing scheme to a downloadable file of the software application, and in 440, the method includes transmitting the downloadable file having the dynamically assigned licensing scheme to a computing system associated with the download. For example, the computing system may be the intervening edge server which installs the downloadable file on the asset control system. As another example, the computing system may be the asset control system which receives the downloadable file directly. In some embodiments, the assigning may include embedding the determined licensing scheme, by the application marketplace, into a storage area of the downloadable file of the software application. In some embodiments, the assigning may instead or may also include transmitting the licensing scheme information to an external entity for managing usage of the downloaded application by the user device based on the assigned licensing scheme. In some embodiments, the dynamically determining the licensing scheme and the assigning of the licensing scheme to the downloadable file may be performed automatically by the application marketplace in response to receiving the request to download the software application. When the licensing scheme has been assigned, the downloadable file may be transmitted to a computing system of the user that requested the download. As another example, the downloadable file may be transmitted to an intermediate device that is capable of installing the downloadable file onto the user device when the user device is offline.

Furthermore, the licensing scheme may be updated periodically or in response to a request from a user. For example, when the licensing scheme is updated, the application marketplace may trigger updated licensing scheme information to be incorporated into the downloadable file and refresh or resend the download. As another example, the licensing information may be transferred to the license management system and may not require a user to refresh or re-download the application again.

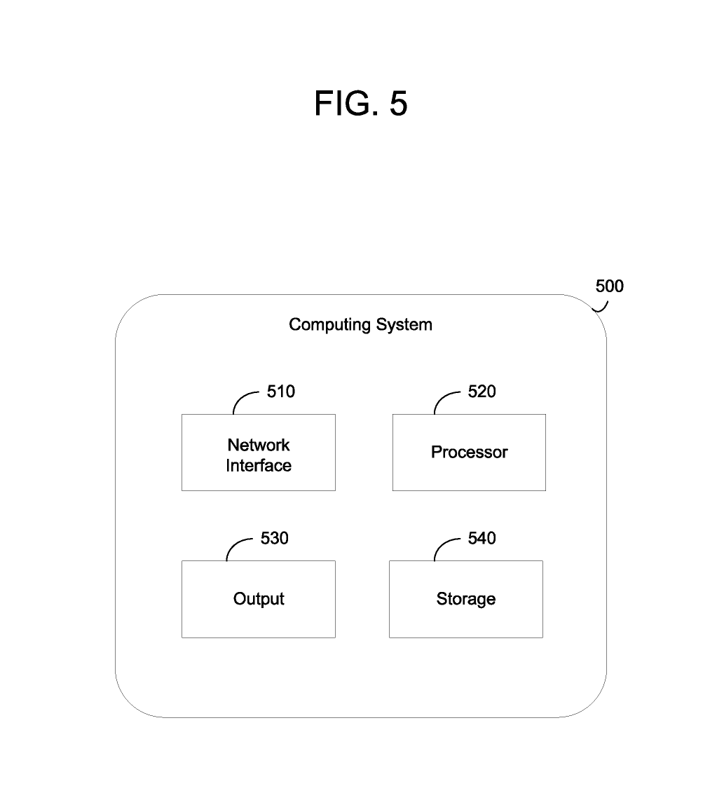

FIG. 5 illustrates a computing system for dynamically assigning licensing information to an application in accordance with an example embodiment. For example, the computing system 500 may be a database, cloud platform, streaming platform, user device, and the like. As a non-limiting example, the computing system 500 may be the host platform 210 shown in FIG. 2 which hosts the application marketplace 220. In some embodiments, the computing system 500 may be distributed across multiple devices. Also, the computing system 500 may perform the method 400 of FIG. 4. Referring to FIG. 5, the computing system 500 includes a network interface 510, a processor 520, an output 530, and a storage device 540 such as a memory. Although not shown in FIG. 5, the computing system 500 may include other components such as a display, an input unit, a receiver, a transmitter, and the like.

The network interface 510 may transmit and receive data over a network such as the Internet, a private network, a public network, and the like. The network interface 510 may be a wireless interface, a wired interface, or a combination thereof. The processor 520 may include one or more processing devices each including one or more processing cores. In some examples, the processor 520 is a multicore processor or a plurality of multicore processors. Also, the processor 520 may be fixed or it may be reconfigurable. The output 530 may output data to an embedded display of the computing system 500, an externally connected display, a display connected to the cloud, another device, and the like. The storage device 540 is not limited to a particular storage device and may include any known memory device such as RAM, ROM, hard disk, and the like, and may or may not be included within the cloud environment. The storage 540 may store software modules or other instructions which can be executed by the processor 520 to perform the method 400 shown in FIG. 4. Also, the storage 540 may store software programs and applications which can be downloaded and installed by a user. Furthermore, the storage 540 may store and the processor 520 may execute an application marketplace that makes the software programs and applications available to users that connect to the computing system 500.

According to various embodiments, the network interface 510 may receive a request to download and install an instance of a software application from the application marketplace. In response to the request, the processor 520 may dynamically determine a licensing scheme to be used for the instance of software application from among a plurality of possible licensing schemes based on configuration information stored in a repository associated with the application marketplace, and assign the dynamically determined licensing scheme to a downloadable file of the software application. The processor 520 may further control the network interface 510 to transmit the downloadable file having the dynamically assigned licensing scheme to a computing system associated with the download. As one example, the processor 520 may embed the determined licensing scheme, via the application marketplace, into a storage area of the downloadable file of the software application as shown in the example of FIG. 3.

In some embodiments, the processor 520 may dynamically determine the licensing scheme and assign the licensing scheme to the downloadable file automatically, via the application marketplace, in response to receiving the request to download the software application. In some embodiments, the processor 520 may control the network interface 510 to transmit information about the determined licensing scheme to a license managing system which controls use of the instance of the software application. For example, the network interface 510 may transmit the downloadable file with the licensing scheme incorporated therein to a computing system of a user that requested the download. In addition, the configuration information stored in the repository may include information received by the application marketplace from a user during a registration process for downloading the software application to a user device.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computer-implemented method comprising:
receiving a request of an asset control system, at an application marketplace, to download and install an instance of a software application from the application marketplace for use with an asset controlled by the asset control system;
dynamically determining a licensing scheme to be used for the instance of the software application from among a plurality of possible licensing schemes based on configuration information stored in a repository associated with the application marketplace;
assigning the dynamically determined licensing scheme to a downloadable file of the software application; and
transmitting the downloadable file having the dynamically assigned licensing scheme to an industrial edge computing system associated with the asset control system.

2. The computer-implemented method of claim 1, further comprising verifying whether the asset control system is entitled to download the requested software application.

3. The computer-implemented method of claim 1, wherein the assigning comprises embedding the determined licensing scheme, by the application marketplace, into a storage area of the downloadable file of the software application.

4. The computer-implemented method of claim 1, wherein the determined licensing scheme comprises a billing policy for the instance of the software application.

5. The computer-implemented method of claim 1, wherein the determined licensing scheme comprises a redistribution restriction policy for the instance of the software application.

6. The computer-implemented method of claim 1, wherein the dynamically determining the licensing scheme and the assigning of the licensing scheme to the downloadable file is performed automatically by the application marketplace in response to receiving the request to download the software application.

7. The computer-implemented method of claim 1, further comprising transmitting information about the determined licensing scheme to a license managing system which controls use of the instance of the software application.

8. The computer-implemented method of claim 1, wherein the transmitting the downloadable file further comprises transmitting the downloadable file with the licensing scheme incorporated therein to the asset control system that requested the download.

9. The computer-implemented method of claim 1, wherein the configuration information stored in the repository comprises information received by the application marketplace during a registration process.

10. A computing system comprising:
a network interface configured to receive a request of an asset control system to download and install an instance of a software application from an application marketplace for use with an asset controlled by the asset control system; and
a processor configured to dynamically determine a licensing scheme to be used for the instance of software application from among a plurality of possible licensing schemes based on configuration information stored in a repository associated with the application marketplace, and assign the dynamically determined licensing scheme to a downloadable file of the software application,
wherein the processor is further configured to control the network interface to transmit the downloadable file having the dynamically assigned licensing scheme to an industrial edge computing system associated with the asset control system.

11. The computing system of claim 10, wherein the processor is further configured to verify whether the asset control system is entitled to download the requested software application.

12. The computing system of claim 10, wherein the processor is configured to embed the determined licensing scheme, via the application marketplace, into a storage area of the downloadable file of the software application.

13. The computing system of claim 10, wherein the determined licensing scheme comprises a billing policy for the instance of the software application.

14. The computing system of claim 10, wherein the determined licensing scheme comprises a redistribution restriction policy for the instance of the software application.

15. The computing system of claim 10, wherein the processor is configured to dynamically determine the licensing scheme and assign the licensing scheme to the downloadable file automatically, via the application marketplace, in response to receiving the request to download the software application.

16. The computing system of claim 10, wherein the processor is further configured to control the network interface to transmit information about the determined licensing scheme to a license managing system which controls use of the instance of the software application.

17. The computing system of claim 10, wherein the network interface is configured to transmit the downloadable file with the licensing scheme incorporated therein to the asset control system that requested the download.

18. The computing system of claim 10, wherein the configuration information stored in the repository comprises information received by the application marketplace from a user during a registration process for downloading the software application to a user device.

19. A computer-implemented method of an industrial edge system, the computer-implemented method comprising:
receiving a downloadable file for installing a software application from an application marketplace, the downloadable file comprising licensing scheme data associated with a licensing policy for the software application which is dynamically assigned by the application marketplace from among a plurality of licensing schemes;
installing the software application and initiating a monitoring operation for the software application based on the licensing scheme data; and
optimizing a performance an industrial asset coupled to the industrial edge system using the software application.

20. The computer-implemented method of claim 19, further comprising transmitting a download request for the software application to at least one of the application marketplace host and an intervening edge server.

21. The computer-implemented method of claim 19, further comprising extracting the licensing scheme data from an embedded storage area of the downloadable file.

22. The computer-implemented method of claim 19, wherein the initiating the monitoring application comprises transmitting application data and an identification of the industrial edge system to a licensing management system associated with the application marketplace.

23. The computer-implemented method of claim 19, wherein the downloadable file further comprises a monitoring component, and the initiating the monitoring operation is performed by executing the monitoring component on the industrial edge system.

24. The computer-implemented method of claim 23, wherein the monitoring component on the industrial edge system attaches to a software component executing on an asset control system associated with the industrial edge system for monitoring performance of an asset coupled to the industrial edge system.
